(19) United States
(12) Patent Application Publication
(10) Pub. No.: US 2013/0341148 A1
(43) Pub. Date: Dec. 26, 2013

(54) SYNCHRONIZER RING

(71) Applicant: Sulzer Friction Systems (Germany) Gmbh, Bremen (DE)

(72) Inventor: Ulf Christoffer, Bremen (DE)

(21) Appl. No.: 13/915,705

(22) Filed: Jun. 12, 2013

(30) Foreign Application Priority Data
Jun. 20, 2012 (EP) 12172704.4

(51) Int. Cl. F16D 23/02; B23P 15/14

(52) U.S. Cl. CPC F16D 23/025; B23P 15/14
USPC 192/53.34; 29/893.3

(57) ABSTRACT

A synchronizer ring (1) for a synchronizer of a switchable gear changing transmission, includes a ring body (2) having a synchronizer ring axis (3), which ring body has an inner friction surface (4) and an outer installation surface (5), wherein the inner friction surface (4) and the outer installation surface (5) bound the ring body (2) as jacket surfaces. The ring body has an end face (13) and a gear surface (8) opposite the end face, wherein the synchronizer ring has a width (15) which corresponds to the shortest distance between the end face (13) and the gear surface (8) and the jacket surfaces extend between the end face (13) and the gear surface (8), wherein the ring body (2) has a toothed arrangement (6) which extends radially outwardly from the outer installation surface (5), wherein the toothed arrangement has a crown gear (9) which extends from the gear surface (8) via a part of the width (15) of the ring body (2) in the direction of the end face (13), characterized by a recess (10) which is arranged at the inner friction surface (4) of the ring body (2), so that the radius (14) of the inner friction surface (4) in the region of the recess (10) is larger than the radius (12) of the inner friction surface (4) at the end face (13), and wherein a bulge (11) is provided at the outer installation surface (5) which is arranged in the radial direction over the recess (10).

The invention relates to a synchronizer ring for a synchronizer for a switchable gear changing transmission, as well as to a switching transition for a vehicle. Furthermore, the invention relates to synchronizer including a synchronizer ring for a switchable gear changing transmission. The synchronizer can be used in a vehicle transmission. The invention also relates to a method for the manufacture of a synchronizer ring.

In a mechanical switchable gear changing transmission synchronizer rings serve the purpose of matching the relative speeds between gear wheel and transmission shaft to one another which relative speeds result during a gear change.

The transmission shaft is connected to the corresponding gear wheel in a force transmitting manner via a toothed gear arrangement, so that the output shaft can be driven at the desired number of revolutions. A plurality of gear wheels is arranged at the output shaft which have different gear ratios. Accordingly, the number of revolutions of the output shaft can be correspondingly higher or lower than the number of revolutions at the drive shaft. The switching from a gear wheel to a different gear wheel should, if possible, not take place under load.

For this reason synchronizer rings are provided for the synchronization in order to match the number of revolutions to the desired number of revolutions free in a load free manner before a force transmitting connection is brought about between the drive wheel and the gear wheel. For this purpose the crown gear of the synchronizer ring engages into the shifting collar which serves for the force transmitting connection of the gear wheel to the drive shaft in the coupled state. For this purpose the synchronizer ring has at least one friction surface which can be connected to the drive shaft or a coupling element coupled to the drive shaft in a friction locking manner. When the friction surfaces are connected to the coupling element in a friction locked manner, the drive number of revolutions is transferred to the synchronizer ring. The number of revolutions of the shifting collar is matched to the drive number of revolutions via the crown gear of the synchronizer ring. As soon as the gear wheel rotates with the same number of revolutions as the shifting collar the shifting collar can engage in a force transmitting connection of the gear wheel and a load-free switching process can be carried out, in that the shifting collar undergoes a force transmitting connection with the gear wheel. The functional principle of such gear changing transmissions is known per se.

To protect against premature wear and/or to improve the friction characteristics it is known to provide the friction surfaces of synchronizer rings with a friction lining.

A synchronizer ring is generally made of a base body of metal or of a metal alloy which, in particular can include brass or steel. The friction lining can, for example, include molybdenum. Such a friction lining is applied as a thermal spray layer onto the base body. Alternatively, such a friction lining can also include carbon or carbon-containing compounds. Naturally, these preferred embodiments are not to be understood in any way as being limiting to the mentioned layers. Each other layer which increases the friction between the friction surfaces and satisfies the requirements on temperature, as well as on resistance to wear can in principle be used as a friction lining.

From the state of the art synchronizer rings are known which are of one-piece design or which can also be composed of a plurality of parts. A synchronizer ring is composed of at least one ring-shaped component and can, in particular also be of two-part or three-part design and in accordance with the last mentioned embodiment can have an outer ring, an inner ring and an intermediate ring arranged between the outer ring and the inner ring. The synchronizer ring has at least one index cam which is connected to a synchronizer body in a suitable manner. The indexing generally takes place via the index cam at the synchronizer ring. On the manufacture of synchronizer rings of steel sheet metal parts the index cams, which connect the synchronizer ring to the synchronizer body, are bent over from the steel sheet metal part. In particularly constricted construction spaces the problem results that the lugs have to be bent extremely close to the ring body. Hereby the risk of breaks increases.

Lugs which are of narrow design and additionally exceed a certain minimum length tend to break on bending.

For this reason it is the object of the invention to reduce the danger of breaks of lugs.

The object is satisfied by the features in accordance with the independent claim 1. The dependent claims 2 to 11 describe advantageous embodiments. Claim 12 is directed to a synchronizer, this means that the synchronizer ring is designed in connection with the elements which satisfy the function in the gear changing transmission. Claim 13 is directed to a gear changing transmission which includes a synchronizer in accordance with claim 12. Claim 14 relates to the description of the method for the synchronization. Claim 15 relates to a method for the manufacture of a synchronizer ring

A synchronizer ring for a synchronizer of a switchable gear changing transmission includes a ring body having a synchronizer ring axis, which ring body has an inner friction surface and an outer installation surface, wherein the inner friction surface and the outer installation surface bound the ring body as jacket surfaces. The ring body has an end face and a gear surface opposite the end face. The synchronizer ring has a width which corresponds to the shortest distance between the end face and the gear surface. The jacket surfaces extend between the end face and the gear surface. The ring body has a toothed arrangement which extends radially outwardly from the outer installation surface. The toothed arrangement has a crown gear which extends from the gear surface via a part of the width of the ring body in the direction of the end face. In accordance with the invention a recess is arranged at the inner friction surface of the ring body so that the radius of the inner friction surface in the region of the recess is larger than the radius of the inner friction surface at the end face. A bulge is provided at the outer installation surface which is arranged in the radial direction over the recess. The inner friction surface can be provided with a coating which can, in particular be configured as a friction lining. The friction lining can, in particular include a carbon coating. This coating can, in particular include granulated carbon particles on an aramid fiber support layer, a carbon fiber reinforced cellulose layer or a web of carbon fiber. Alternatively, also a coating can be applied by means of a thermal spray method whereby, in particular a porous molybdenum layer or a titanium alloyed bronze layer can be applied onto the friction surface.

The synchronizer in accordance with the present invention thus includes an indexing for the rotationally secure guidance of the synchronizer ring in the synchronizer body. The indexing is formed by the recess or the plurality of recesses which are arranged at the inner friction surface of the ring body of the synchronizer ring. A large advantage of the recess in accordance with the invention as well as the corresponding bulge is thus given thereby that the combination of bulge and recess can satisfy a plurality of functions. For example, it can serve for the rotationally secure guidance of the synchronizer in the synchronizer body and/or as a point of application of the pre-synchronizer elements.

Furthermore, it is of advantage that both the bulge and also the recess can be manufactured in a single work step from a deep drawn ring body or formed ring body. The index cams are not formed as lugs, which are bent over, but rather an indexing is provided which is formed from the ring body. Advantageously, a plurality of recesses and/or bulges can be arranged at the circumference of the inner friction surface or of the outer installation surface. In particular the recesses and/or bulges can be arranged at the same distance to one another, for example, four recesses and/or bulges can be arranged respectively at a degree of 90° with respect to one another. Hereby, a skewing of the synchronizer relative to the shifting collar can be avoided and a precise synchronization process is ensured.

In accordance with an embodiment the recess or each of the recesses has a maximum longitudinal dimension which is less than 10% of the circumference of the inner friction surface at the end face. The smaller the aerial portion of the recess of the inner friction surface is the less friction surface is lost. Furthermore, the weakening of the synchronizer ring clue to the recess is smaller, this means that the strength parameters of the synchronizer ring are less strongly reduced, in particular by the reduced notch effect than for a recess with dimensions which amount to more than 10% of the inner friction surface.

For a synchronizer ring for a synchronizer having small indexing the formation, i.e. the recess with the associated bulge can be designed such that the crown gear can extend over the overall circumference of the synchronizer ring. The crown gear is not interrupted in this case.

For a synchronizer ring for a synchronizer having a large indexing more material must be moved during the deforming. In this case the indexing can be preformed in the flat state. The synchronizer ring is manufactured from a blank which is designed as a ring-shaped disc. In a first method step this disc is deformed such that a pot-shaped intermediate product results. This forming step can advantageously be carried out by deep drawing or forming. The final shape of the synchronizer ring is determined from the pot-shaped intermediate product by a subsequent process. In this case the crown gear is interrupted.

In accordance with an embodiment, at least the inner friction surface is, at least sectionally, of conical design. The angle of inclination of the conical inner friction surface with respect to the synchronizer ring axis, in particular amounts to up to 60°. The docking and removal of the synchronizer ring from the corresponding friction surface of a gear wheel can be simplified through a conical inner friction surface. A blocking of the synchronizer ring in the corresponding position can be avoided, in particular through the conical design of the inner friction surface, this means that the connection can be coupled and be decoupled at any point in time. With regard to the angle of inclination this can generally be matched freely to the corresponding assembly conditions.

In accordance with further embodiments which have been found advantageous, the synchronizer ring can be designed of multiple stages. The synchronizer ring, in particular has an outer ring, an intermediate ring and an inner ring. The intermediate ring has an outer friction surface and an inner friction surface. The outer friction surface faces the friction surface of the outer ring and the inner friction surface faces the friction surface of the inner ring. The use of a multi-stage synchronizer ring, in particular offers the advantage that the overall surface of the friction surfaces which are in frictional contact with one another can be increased.

In accordance with an embodiment the ring body can be formed from a steel sheet metal part. Besides the cost advantages associated with the use of a steel sheet metal part, also the processing of a steel sheet metal part in a deep drawing and/or forming process can be enabled simply and cost-effectively due to the ductile properties of the steel.

Also the forming process or the deep drawing process for the manufacture of the recess and of the bulge can be carried out simply, so that, in particular on use of a steel sheet metal part, it is possible to carry out the forming process in a single work step. In particular the wall thickness of the bulge can substantially correspond to the wall thickness of the ring body.

In accordance with an embodiment the wall thickness of the bulge is at most twice as large as the maximum depth of the recess measured in the radial direction. In this case only one single work step is required for the manufacture of the bulge as well as of the recess. The bulge and recess can, in particular be manufactured in one and the same work step. The plastic deformation of the ring body brings about a local introduction of pre-loads in the deflection regions. This pre-loading can be of advantage in the installed state when a radial pressure force acts on the bulge.

The recess and/or bulge can extend over the overall width of the ring body. For this embodiment the crown gear can, in particular be interrupted in the region of the recess and/or bulge. Hereby an unhindered formation of the recess and/or bulge is possible when the forming process is carried out. Naturally, the crown gear can also be interrupted when the recess and/or bulge is not continuously formed over the overall width of the ring body. This is because, in accordance with an alternative embodiment, the recess and/or bulge can extend over a part of the width of the synchronizer ring.

The present invention thus enables a so-called “drop-in” solution for the synchronizer ring also when only a very limited construction space is available. A so-called “drop-in” solution is characterized in that a present synchronizer ring can be replaced by the new component without any changes of the surrounding components.

The danger of breaks for narrow and/or long lugs can be avoided. For this reason, the possibility exists to realize narrow and/or long lugs for which no danger of breaks is present. Individual segments can be guided without the risk of loss in the recess or grooves, when the synchronizer ring is designed in a segmented manner of construction.

The invention further relates to a synchronizer which includes a synchronizer ring in accordance with any one of the proceeding embodiments, as well as including a synchronizer body. The synchronizer ring is receivable in a reception element of the synchronizer body such that the bulge or recess of the ring body engages in the reception element of the synchronizer ring, so that the synchronizer ring is coupled to the synchronizer body.

The invention further relates to a vehicle transmission, including a synchronizer in accordance with any one of the preceding embodiments which includes at least one synchronizer ring in accordance with any one of the preceding embodiments.

The invention further relates to a method for the synchronization of a multi-stage switchable gear changing transmission including a drive shaft, a drive shaft gear rotationally fixedly connected to the drive shaft, an output shaft as well as a plurality of gear wheels which are arranged on the output shaft, as well as including a synchronizer for the force-transmitting connection of the drive shaft to the output shaft via the drive shaft gear and a respective one of the gear wheels. The number of revolutions of the drive shaft gear is synchronized with the number of revolutions of the gear wheels such that the coupling of the drive shaft gear to the gear wheel takes place in a forceless manner via the synchronizer. A pre-synchronization can take place in a first step. During the pre-synchronization the shifting collar is brought into engagement with the pre-synchronization element and/or with the synchronizer body and the synchronizer ring, such that the synchronizer ring is rotationally fixedly connected to the synchronizer body and/or the pre-synchronizer element. The synchronizer ring can be received in a reception element of the synchronizer body such that the bulge or recess of the ring body of the synchronizer ring engages into the reception element so that the synchronizer ring is coupled to the synchronizer body and such that the synchronizer ring can be driven at the number of revolutions of the shifting collar. The synchronizer ring is connected in a friction locking manner to the coupling element of the gear wheel. In a second step the synchronization takes place. Through the movement of the shifting collar the gear wheel can be driven via the friction surface and the coupling element, so that a matching of the number of revolutions of the gear wheel to the number of revolutions of the drive shaft and of the drive shaft gear takes place via the friction effect of the friction surface and, on synchronized speed, the shifting collar is displaced in the axial direction such that the toothed arrangement of the synchronizer ring is brought into engagement with the corresponding toothed arranged of the gear wheel via an inner toothed arrangement of the shifting collar, so that a form-fitting connection between the gear wheel and the drive shaft gear drivable via the shifting collar takes place, in order to enable a force transfer from the drive shift gear to the gear wheel.

The pre-synchronizer element can, for example, be formed form a plurality of sliding stones and at least one spring element. Preferably, at least two ring springs are used as the spring element. The synchronizer ring can, in particular be coupled to the pre-synchronizer element via the bulge or recess, so that the synchronizer ring can commonly be moved with the pre-synchronizer element.

The method for the manufacture of a synchronizer ring includes the steps of forming a pot-shaped ring body by deep drawing or forming and the forming of at least one part of the ring body to a recess and a corresponding bulge is effected.

In the following the invention will be described in detail with reference to the enclosed drawing.

There is shown

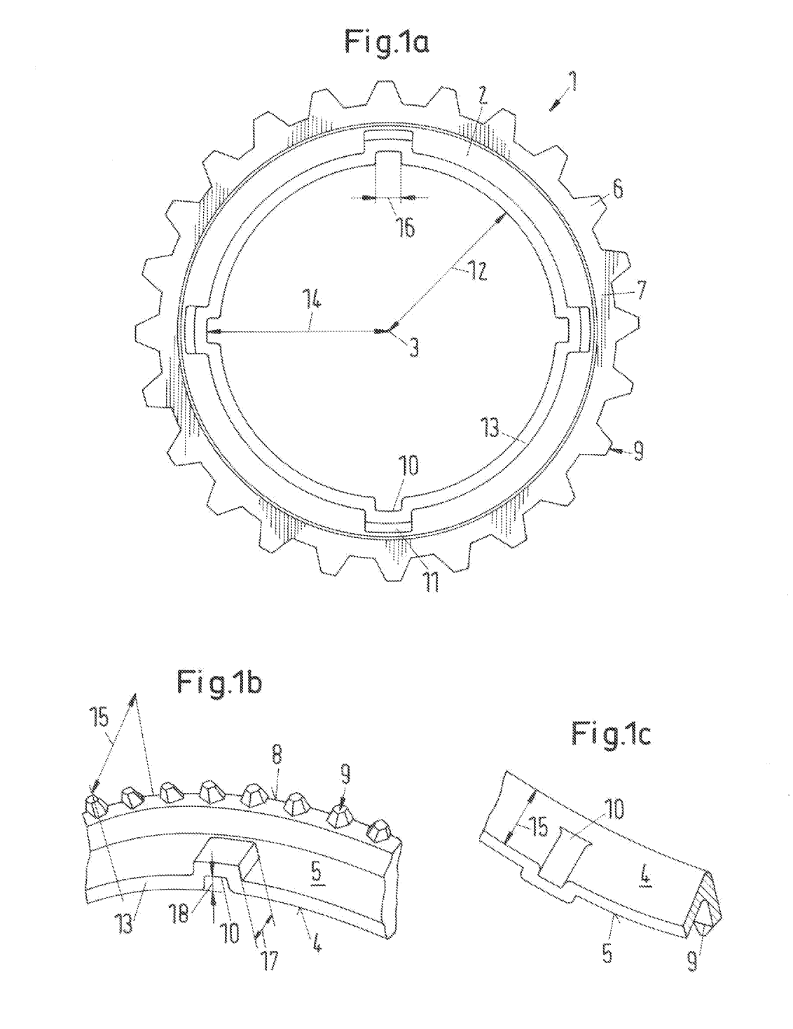

FIG. 1a a view of a synchronizer ring in accordance with a first embodiment;

FIG. 1b a detail of the outer side of a synchronizer ring in accordance with FIG. 1a;

FIG. 1c a detail of the inner side of the synchronizer ring in accordance with FIG. 1a;

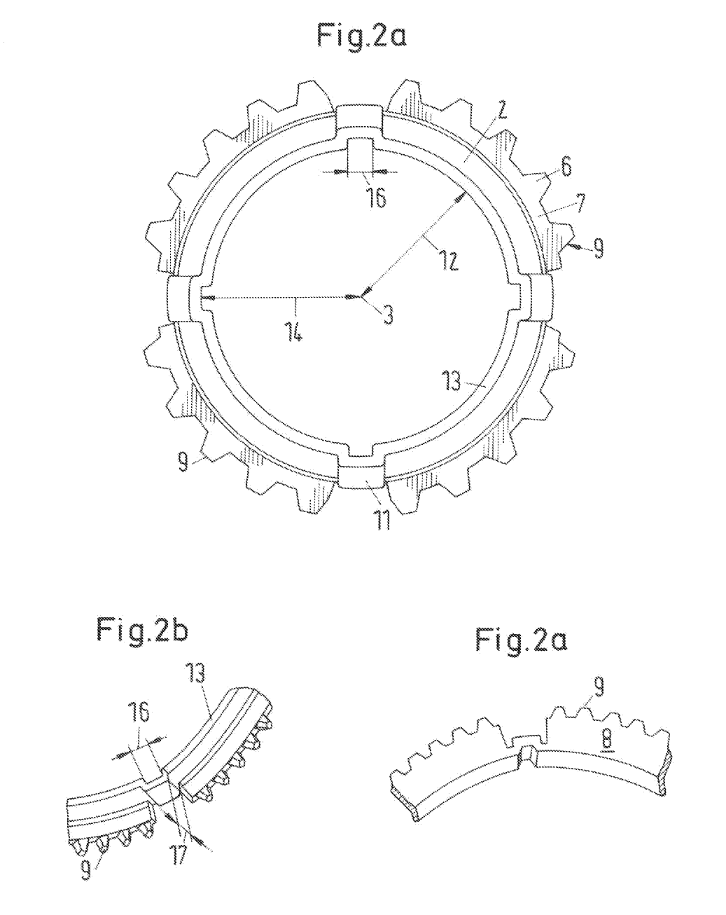

FIG. 2a a view of a synchronizer ring in accordance with a second embodiment;

FIG. 2b a detail of the outer side of the synchronizer ring in accordance with FIG. 2a;

FIG. 2c a detail of the inner side of the synchronizer ring in accordance with FIG. 2a;

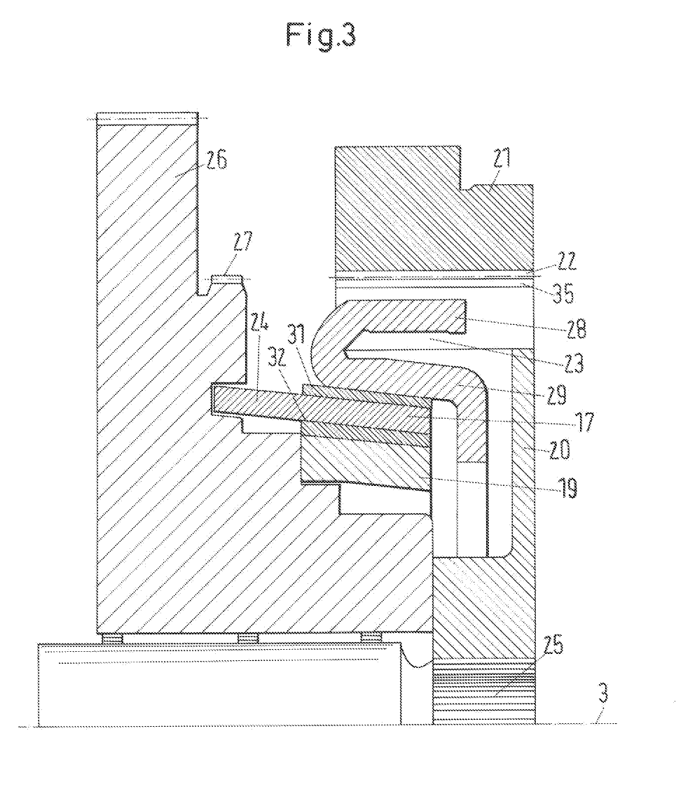

FIG. 3 a section through an arrangement of a synchronizer ring in a synchronizer in accordance with the state of the art;

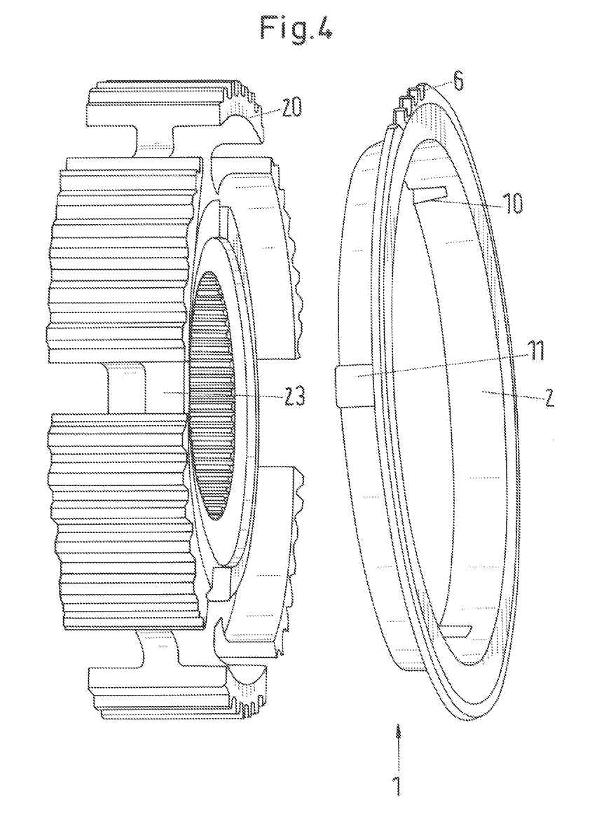

FIG. 4 a synchronizer in accordance with the invention;

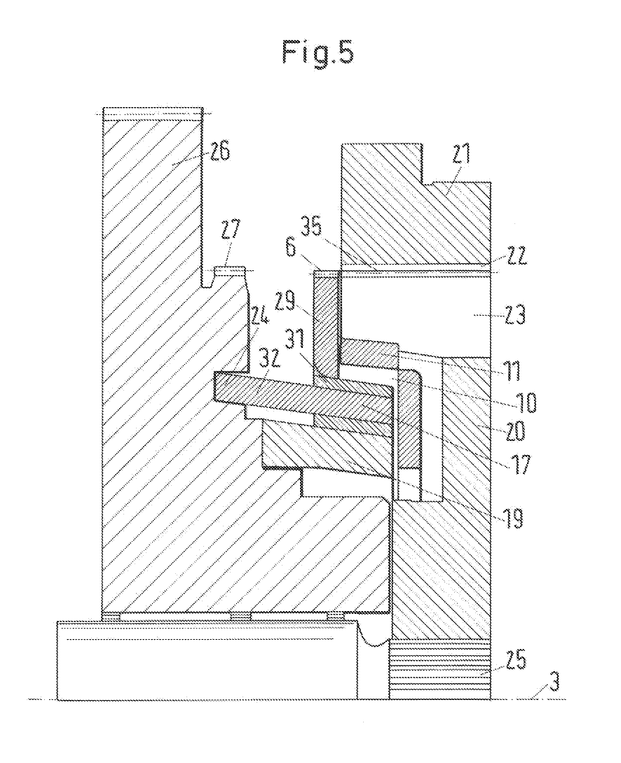

FIG. 5 a section through a synchronizer in accordance with the invention in accordance with an embodiment of a multi-cone synchronizer;

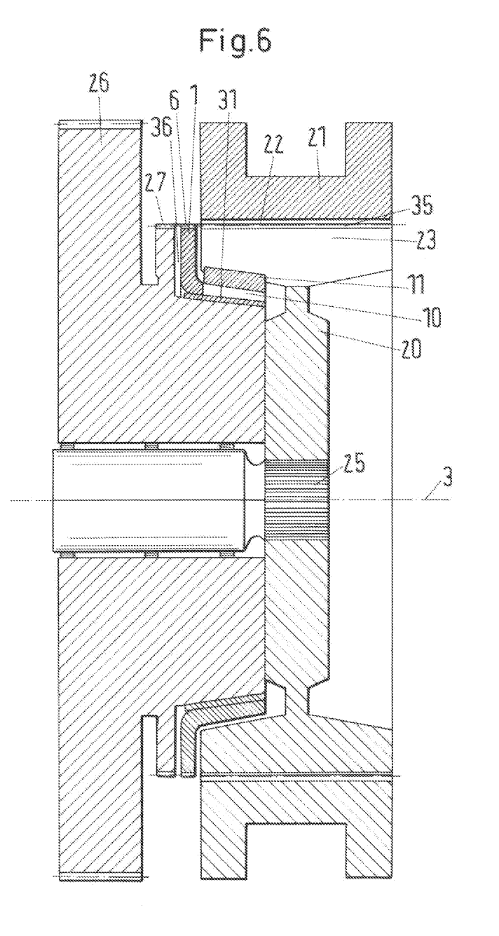

FIG. 6 a section through a synchronizer in accordance with the invention in accordance with an embodiment of a one-fold cone synchronizer.

The synchronizer ring 1 in accordance with FIG. 1a for a synchronizer of a switchable gear changing transmission has a ring body 2. The ring body 2 is arranged about a synchronizer ring axis 3. The ring body has an inner friction surface 4 and an outer installation surface 5. The inner friction surface 4 and the outer installation surface 5 bound the ring body 2 in a radial circumferential direction. The ring body 2 has a toothed arrangement 6 which extends from a gear basic strip 7 surrounding the ring body in the radial direction and present at an end of the ring body. The gear basic strip 7 is bound in the axial direction by a gear surface 8 extending substantially perpendicular to the synchronizer ring axis. The gear basic strip 7 supports the teeth of the toothed arrangement 6. A recess 10 is arranged at the inner friction surface 4 of the ring body 2, so that the radius 14 of the inner friction surface 4 at the end face 13 in the region of the recess 10 is larger than the radius 12 of the inner friction surface 4.

The recess 10 has a substantially rectangular cross-sectional area. The longitudinal sides of the rectangle extend substantially in parallel to the synchronizer ring axis 3. Alternatively, the possibility exists that the recess is of trapezoidal design which is not shown in the Figures by way of illustration. The base of the trapezium lies at the end face 13.

The recess 10 extends in accordance with FIG. 1a, FIG. 1b or FIG. 1c over a part of the width of the synchronizer ring. The width is defined as the dimension which is measured between the end face 13 and the gear surface 8 and which extends in parallel to the synchronizer ring axis. A bulge 11 is provided at the outer installation surface 5 which is arranged in the radial direction above the recess 10.

The synchronizer ring 1 is advantageously manufactured by deep drawing or forming, in particular of the ring body. The recess 10 and/or the bulge 11 can be manufactured in a further work step by a forming process or deep drawing process. In particular, when the wall thickness of the bulge 11 is at most twice as large as the maximum depth 18 of the recess 10, measured in the radial direction, the recess 10 and the bulge 11 can be manufactured in a single work step.

The embodiment in accordance with FIGS. 2a, 2b and 2c differs from the embodiment in accordance with FIG. 1a, 1b, 1c, such that the recess 10 and the associated bulge 11 extend over the overall width of the ring body 2. Furthermore, this embodiment differs such that the crown gear 9 is interrupted in the region of the bulge 11.

FIG. 3 shows a gear changing transmission including a synchronizer in accordance with the state of the art which has a multi-stage synchronizer ring 1, as well as a shifting collar 21 which is displaceable along the synchronizer ring axis 3. The synchronizer ring can be received in a reception element 23 of the synchronizer body 20 such that the bulge 11 or recess 10 of the ring body of the synchronizer ring 1 engage in the reception element 23 so that the synchronizer ring 1 is coupled to the synchronizer body 20.

The shifting collar 21 has an inner toothed arrangement 22 which engages into a pre-synchronizer element (not illustrated), as well as with the synchronizer ring 1 with a toothed arrangement not illustrated in the present example, since the section is placed at a position of the synchronizer ring 1 at which the toothed arrangement is interrupted.

The synchronizer ring in accordance with FIG. 3 is assembled from an outer ring 29, an inner ring 19 and an intermediate ring 17 arranged between the outer ring 29 and the inner ring 19. An outer friction element 31 is arranged between the outer ring 29 and the intermediate ring 17. An inner friction element 32 is arranged between the intermediate ring 17 and the inner ring 19.

This common multi-cone synchronizer thus has a synchronizer ring having an outer ring 29 which engages with a bent over lug 28 in a reception element 23 of the synchronizer body 20. The intermediate ring 17 engages in the gear wheel 26 by means of a coupling element 24, in particular a lug. The inner ring 19 is likewise coupled to the outer ring 29 via a non-illustrated lugs, so that the inner ring 19, rotates together with the outer ring 29. The outer ring 29 of the synchronizer ring 1 is thus coupled to the synchronizer body 20 in a rotationally secure manner. The synchronizer body 20 is in turn rotationally fixedly connected to the output shaft 25. The synchronizer body can include a pre-synchronizer element which can be held in its radial position via spring elements which are, in particular formed as ring spring elements. The pre-synchronizer element can, in particular be formed as a plurality of sliding stones. However, it is also possible that the synchronizer ring 29 is at least partly received in the pre-synchronizer element, which is not shown in the drawings.

In the position illustrated in FIG. 3 the synchronizer body 20 rotates with the synchronizer ring 1 coupled thereto, this means that its outer ring 29 and its inner ring 10 rotate with the number of revolutions of the output shaft. A connection to the intermediate ring 17 in a friction locking manner exists via the outer friction element 31 and the inner friction element 32. The intermediate ring 17 is adapted with a coupling element 24 which is in engagement with the gear 26. The gear 26 is thus moved via the coupling element with the synchronizer ring 1. When synchronizer body 20 and gear 26 run at the same number of revolutions, the shifting collar 21 can be displaced by a non-illustrated manipulation element such that its inner toothed arrangement 22 can be brought into engagement with the toothed arrangement 26 attached at the gear 26 of the coupling body of the gear wheel. In this position both the toothed arrangement of the outer ring 29 of the synchronizer ring 1 and also the toothed arrangement 27 of the gear having the inner toothed arrangement 22 of the shifting collar 21 are in engagement, so that a force transmitting connection from the gear wheel 16 via its toothed arrangement 27, the toothed arrangement 6 of the outer ring 29 with the inner toothed arrangement 22 of the shifting collar 21 results, whereby the output shaft 25 is coupled to the gear 26. This means that in this position a force can be transferred from the drive shaft to the gear 26.

FIG. 4 shows a synchronizer body 20, as well as a synchronizer ring 1 in accordance with an embodiment of the present invention. The bulge 11 engages in a corresponding recess 23 of the synchronizer body 20, so that the synchronizer ring is in engagement with the synchronizer body 20. The bulge 11 and/or recess 10 are present at the ring body 2 of the synchronizer ring 1, so that, on a force transfer during the synchronizer process via the recess and/or bulge, the ring body 2 and/or the synchronizer body 20 is moved such that their number of revolutions match. Local stress peaks which lead to the failure of the lug 28 in accordance with an embodiment of the state of the art are thus avoided through the provision of a connection between synchronizer ring 1 and synchronizer body 20 via the bulge 11 and/or the recess 10 which engage in a reception element 23 of the synchronizer body 20.

Naturally, the illustrated synchronizer ring 1 can be designed as an outer ring 29 of a multi-stage synchronizer ring which is illustrated in FIG. 5. Thus, FIG. 5 shows the arrangement of the synchronizer ring of a gear changing transmission which has the same components like in FIG. 3 and whose function shall not be explained in further detail. The synchronizer ring 29 is received in the synchronizer body 20. The synchronizer ring 29 has a toothed arrangement 6. Also the synchronizer body 20 has an outer toothed arrangement 35 which is in engagement with the inner toothed arrangement 22 of the shifting collar 21. The bulge 11 of the synchronizer ring 29 is received in the reception element 23 of the synchronizer body. As is illustrated in FIG. 4, a plurality of such bulges can be arranged at the circumference of the synchronizer ring 29 between the inner friction surface and the outer installation surface. Hereby the configuration of the synchronizer ring 29 for these features corresponds to the illustration of the synchronizer ring 1 in accordance with any one of the FIG. 1a, 1b, 1c, 2a, 2b, 2c.

The method of synchronization of a multi-stage switchable gear changing transmission includes the subsequent steps. The gear changing transmission includes a drive shaft, a drive shaft gear rotationally fixedly connected to the drive shaft, an output shaft 25, as well as a plurality of gears 26 which are arranged on the output shaft, as well as a shifting collar for the force transmitting connection of the drive shaft to the output shaft via the drive shaft gear and a respective one of the gears. FIG. 5 only shows one of the gears. The synchronizer ring 1 is receivable in a reception element 23 of the synchronizer body 20 such that the bulge 11 or recess 10 of the ring body 2 of the synchronizer ring 1 engages in the reception element 23. The synchronizer ring 1 is coupled to the synchronizer body 20 and such that the synchronizer ring 1 is movable at the number of revolutions of the shifting collar 21. The synchronizer ring 1 is connected to a coupling element 24 of the gear 26 via at least one friction surface 31, 32 in a friction locking manner so that, on movement of the shifting collar 21, the gear 26 can be driven via the friction surface 31, 32 and the coupling element 24, so that a matching of the number of revolutions of the gear to the number of revolutions of the drive shaft and the drive shaft gear takes place via the friction effect of the friction surface 31, 32 and, on synchronized speed, the shifting collar is displaced in the axial direction such that the toothed arrangement 6 of the synchronizer ring 1, 29 is brought into engagement with the corresponding toothed arrangement 26 of the gear 26 via an inner toothed arrangement 22 of the shifting collar, so that a form-fitting connection between gear 26 and the drive shaft gear drivable via the shifting collar 21 takes place in order to enable a force transfer from the drive shaft gear to the gear 26.

FIG. 6 shows a synchronizer in accordance with a further embodiment. A gear 26 is illustrated on the left which has a toothed arrangement 27 which is determined for reception in an inner toothed arrangement 22 of a shifting collar 21. On the right hand side, a synchronizer ring 1 adjoins the gear 26. This synchronizer ring 1 is of one-piece design. A friction element 31 is arranged between the synchronizer ring 1 and the conical abutment surface 36 of the gear which corresponds in its function to the outer friction element of FIG. 5. The synchronizer ring 1 is received in a reception element 23 of a synchronizer body 20. The reception element 23 is a recess or a pocket in which a bulge 11 of the synchronizer ring is received. The synchronizer ring 1 is thus in engagement with the synchronizer body 20 and can carry out the rotary movement of the synchronizer body 20. The synchronizer body can be designed similar to the design shown in FIG. 4. It has an outer toothed arrangement 35 which, in the installed state, engages in the inner toothed arrangement 22 of the shifting collar 21. As is visible in FIG. 4, the outer toothed arrangement is attached at the circumference of the synchronizer body. At the position of the reception element this outer toothed arrangement is interrupted.

The toothed arrangement 6 of the synchronizer ring 1 is arranged between the outer toothed arrangement 36 of the synchronizer body and the toothed arrangement 27 at the gear which has the same diameter. The toothed arrangement 6 extends, as can be seen from FIG. 4, over the overall circumference of the synchronizer ring 1.

The shifting collar 21 can be displaced via the outer toothed arrangement 36 of the synchronizer body 20 as well as the toothed arrangement 6 of the synchronizer ring 1 and the toothed arrangement 27 of the coupling body of the gear 26. Hereby the coupled position can be differentiated from the decoupled position. In the coupled position the shifting collar 21 is in engagement with the outer toothed arrangement 26 of the synchronizer body 20 via its inner toothed arrangement 22, as well as the toothed arrangement 6 of the synchronizer ring 1 and the toothed arrangement 27 of the coupling body of the gear. In this position the gear is coupled and a force transfer from a non-illustrated drive shaft to the output shaft 25 can take place. In the decoupled position at least the toothed arrangement 27 of the coupling body of the gear 26 is no longer in engagement with the inner toothed arrangement 22 of the shifting collar 21. In this position the drive shaft cannot transfer any force onto the gear 26. The synchronizer ring is in turn coupled to the synchronizer body 20 via the bulge 11. The synchronizer body 20 is still in engagement with the inner toothed arrangement 22 of the shifting collar 21 via its outer toothed arrangement 36. If a change should now be made from the decoupled position into the coupled position the shifting collar 21 is pushed forwardly until a friction is present between the friction elements 31 and the gear cone for the synchronization of the toothed arrangement 6 of the synchronizer ring 1 via the inner toothed arrangement 22 of the shifting collar. (The pre-synchronization is not shown and described in this section.) Since the synchronizer ring 1 is in contact with the conical abutment surface 36 of the gear via the friction elements 31 the number of revolutions of the gear is matched to the number of revolutions of the synchronizer body. If the difference in number of revolutions has been depleted, the inner toothed arrangement 22 of the shifting collar 21 can be brought into engagement with the toothed arrangement 27 of the coupling body of the gear 26 and the coupling can be carried out.

1. A synchronizer ring (1) for a synchronizer of a switchable gear changing transmission, including a ring body (2) having a synchronizer ring axis (3), which ring body has an inner friction surface (4) and an outer installation surface (5), wherein the inner friction surface (4) and the outer installation surface (5) bound the ring body (2) as jacket surfaces, wherein the ring body has an end face (13) and a gear surface (8) opposite the end face, wherein the synchronizer ring has a width (15) which corresponds to the shortest distance between the end face (13) and the gear surface (8) and the jacket surfaces extend between the end face (13) and the gear surface (8), wherein the ring body (2) has a toothed arrangement (6) which extends radially outwardly from the outer installation surface (5), wherein the toothed arrangement has a crown gear (9) which extends from the gear surface (8) via a part of the width (15) of the ring body (2) in the direction of the end face (13), characterized by a recess (10) which is arranged at the inner friction surface (4) of the ring body (2), so that the radius (14) of the inner friction surface (4) in the region of the recess (10) is larger than the radius (12) of the inner friction surface (4) at the end face (13), and wherein a bulge (11) is provided at the outer installation surface (5) which is arranged in the radial direction over the recess (10).

2. A synchronizer ring (1) in accordance with claim 1, wherein a plurality of recesses (10) and/or bulges (11) are arranged at the circumference of the inner friction surface (4) or of the outer installation surface (5).

3. A synchronizer ring (1) in accordance with claim 1, wherein the recess (10) or each of the recesses has a maximum longitudinal dimension (16) which is less than 10% of the circumference of the inner friction surface (4) at the end face (13).

4. A synchronizer ring (1) in accordance with claim 1, wherein at least the inner friction surface (4) is, at least sectionally, of conical design.

5. A synchronizer ring (1) in accordance with claim 4, wherein the angle of inclination of the conical inner friction surface (4) with respect to the synchronizer ring axis (3) amounts to up to 60°.

6. A synchronizer ring (1) in accordance with claim 1, wherein the synchronizer ring has an outer ring, an intermediate ring and an inner ring, and the intermediate ring has an outer friction surface and an inner friction surface, and the outer friction surface faces the friction surface of the outer ring and the inner friction surface faces the friction surface of the inner ring.

7. A synchronizer ring (1) in accordance with claim 1, wherein the ring body (2) is formed from sheet steel.

8. A synchronizer ring (1) in accordance with claim 1, wherein the wall thickness of the bulge (11) corresponds substantially to the wall thickness of the ring body (2).

9. A synchronizer ring (1) in accordance with claim 1, wherein the wall thickness of the bulge (11) is at most twice as large as the maximum depth (18) of the recess (10) measured in the radial direction.

10. A synchronizer ring (1) in accordance with claim 1, wherein the crown gear (9) is interrupted in the region of the bulge (11).

11. A synchronizer ring (1) in accordance with claim 1, wherein the recess and/or the bulge extend(s) over a part of the width of the synchronizer ring.

12. A synchronizer including a synchronizer ring (1) in accordance with claim 1, as well as including a synchronizer body (20), wherein the synchronizer ring (1) can be received in a reception element (23) of the synchronizer body (20) such that the bulge (11) or recess (10) of the ring body (2) of the synchronizer ring (1) engages into the reception element (23) so that the synchronizer ring (1) is coupled to the synchronizer body (20).

13. A gear changing transmission, in particular a vehicle transmission, including a synchronizer in accordance with claim 12 having at least one synchronizer ring (1).

14. A method for synchronizing a multi-stage switchable gear changing transmission, including a drive shaft, a drive shaft gear rotationally fixedly connected to the drive shaft, an output shaft (25), as well as a plurality of gear wheels (26) which are arranged on the output shaft, as well as a synchronizer for the force transmitting connection of the drive shaft and the output shaft via the drive shaft gear and a respective one of the gear wheels, wherein the number of revolutions of the drive shaft wheel is synchronized with the number of revolutions of the gear wheel such that the coupling of the drive shaft gear to the gear wheel takes place forceless via the synchronizer, wherein, during the pre-synchronization, the shifting collar (21) is brought into engagement with the pre-synchronization element and/or the synchronizer body (20) and the synchronizer ring (1), such that the synchronizer ring (1) is rotationally fixedly connected the shifting collar (21) and the pre-synchronization element and/or the synchronizer body (20), wherein the synchronizer ring (1) can be received in a reception element (23) of the synchronizer body (20) such that the bulge (11) or the recess (10) of the ring body (2) of the synchronizer ring (1) engages into the reception element (23) so that the synchronizer ring (1) is coupled to the synchronizer body (20), and such that the synchronizer ring (1) can be driven at the number of revolutions of the shifting collar (21), wherein the synchronizer ring (1) is connected in a friction locking manner to the coupling element (24, 36) of the gear wheel (26), so that, on movement of the shifting collar (21), the gear wheel (26) can be driven via the friction surface (31, 32) and the coupling element (24, 36), so that a matching of the number of revolutions of the gear wheel to the number of revolutions of the drive shaft and of the drive shaft gear takes place via the friction effect of the friction surface (31, 32) and, on synchronized speed, the shifting collar (21) is displaced in the axial direction such that the toothed arrangement (6) of the synchronizer ring (1) is brought into engagement with a corresponding toothed arrangement (27) of a coupling body of the gear wheel (26) via an inner toothed arrangement (22) of the shifting collar (21), so that a form fitting connection between the gear wheel (26) and the drive shaft gear driveable via the shifting collar (21) takes place, in order to enable a force transfer from the drive shaft gear to the gear wheel (26).

15. A method for the manufacture of a synchronizer ring (1) in accordance with claim 1, including the steps of forming a pot shaped ring body (2) by deep drawing or forming, wherein a forming of at least one part of the ring body (2) to a recess (10) and a corresponding bulge (11) is affected.
